(19) United States
(12) Patent Application Publication
(10) Pub. No.: US 2013/0130209 A1
(43) Pub. Date: May 23, 2013

(54) METHODS AND APPARATUS FOR FOREIGN LANGUAGE INSTRUCTION VIA A TOUCH INTERFACE

(71) Applicant: Matthew Fischler, San Diego, CA (US)

(72) Inventor: Matthew Fischler, San Diego, CA (US)

(21) Appl. No.: 13/300,546

(22) Filed: Nov. 18, 2011

(51) Int. Cl. G09B 19/06

(52) U.S. Cl. 434/157

(57) ABSTRACT

Methods and apparatus for foreign language instruction. In one exemplary aspect, a “cascading” user interface is used for foreign language instruction in limited form factor devices. The cascading user interface is based on a “multiple choice” type selection, where each selection is further “modified” in subsequent selections. By cascading multiple steps for each translation step, the device can represent a significantly larger set than would otherwise be possible, given the limitations of the user interface. Proper (and improper) selection may be indicated e.g., via a chime, animation, etc.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates generally to graphical interface for personal media devices, and more particularly to a software aid for language instruction implemented within computing devices.

2. Description of Related Art

Traditionally foreign language instruction generally consisted of rote memorization of vocabulary and/or grammatical rules. Rote memorization can be easily implemented with primitive technologies within a classroom setting (e.g., pencil and paper, flash cards, text books, etc.) However, as technologies have improved, so has foreign language instruction. Today, there is a wide market for educational software that provides interactive tools to stimulate and encourage student learning.

One peculiarity of human languages is that every language obeys certain grammatical rules that are specific to the language. These grammatical rules modify words and phrases in regular and predictable ways, and yet, mastery of these rules is generally the most difficult hurdle to learning a foreign language. Many times a student can learn the vocabulary, but without the proper understanding of the grammatical framework the student cannot translate even simple sentences.

Current foreign language instruction programs require the student to correctly translate a word, fragment or sentence. Unfortunately, these existing solutions suffer from multiple complications and inconveniences. For example, one common type of user interface is a free-form text input (e.g., via a real or virtual keyboard). While free-form text input offers significant flexibility in the type and variety of exercises that can be performed; free-form text input is very unforgiving. A misspelled (but otherwise correct) word is as “wrong” as a completely different word. On the other end of the spectrum there exist multiple choice type user interfaces that are overly forgiving, and cannot easily represent the full depth of actual language.

Recent growth in personal computing platforms capabilities (particularly consumer electronics platforms), has created new opportunities for teaching foreign languages, but the aforementioned deficiencies in prior art foreign instruction programs are only further exacerbated by the form factor limitations of such personal computing platforms. Specifically, small personal computing devices have limited screen space, and seldom use physical keyboards (most rely on a virtualized keyboard). Free-form text entry is especially cumbersome on touch screen virtual keyboards. Similarly, multiple choice type interfaces can only handle a few selectable elements on small screens. The large number of variations possible within the human language is too unwieldy for the limited screen real estate of most mobile devices.

Therefore, improved solutions are needed for implementing foreign language instruction within personal computing devices is needed. Ideal solutions should provide both convenience of use and depth of capability.

### BRIEF SUMMARY OF THE INVENTION

In one aspect, a method for foreign language instruction via a limited user interface is disclosed. In one embodiment, the method includes segmenting a first sentence in a first language into a plurality of first parts of speech; and for one or more of the first parts of speech: displaying the one or more first part of speech; displaying a plurality of translated parts of speech in a second language; wherein each one of the plurality of translated parts has a corresponding selectable element, and one of the translated parts corresponds to the displayed one or more first part of speech; responsive to a user selection of the corresponding one translated part, indicating a successful selection; and otherwise indicating an unsuccessful selection.

In a first variant, the method includes responsive to the successful selection, displaying a plurality of modified parts of speech in a second language, wherein each one of the plurality of modified parts has a second corresponding selectable element, and one of the modified parts corresponds to the corresponding one translated part; responsive to a user selection of the corresponding one modified part, indicating a successful selection; and otherwise indicating an unsuccessful selection.

In a second variant, the corresponding one translated part has not been modified with respect to the translated part use in the first sentence.

In a third variant, at least a subset of the first parts of speech comprises one or more verbs.

In a fourth variant, the plurality of translated parts are selected randomly.

In a fifth variant, the plurality of translated parts are selected based at least in part on the corresponding one translated part.

In a embodiment, the method includes displaying an English verb, the verb having a context within a first sentence; displaying a plurality of Spanish verbs, wherein each one of the Spanish verbs has a corresponding selectable element, and one of the Spanish verbs corresponds to the English verb; responsive to a user selection of the Spanish verb that corresponds to the English verb, displaying a plurality modified versions of the Spanish verb, where one of the modified Spanish verbs corresponds to the context within the first sentence; and responsive to a user selection of the modified Spanish verb corresponding to the context within the first sentence, indicating a successful selection.

In one variant, the indicating comprises at least one of: an audible indication, a visual indication, and a vibration.

In a second variant, the plurality of Spanish verbs are displayed in their infinitive form.

In a third variant, additionally including storing a user progress.

In yet a third embodiment, the method comprises displaying a first part of speech; prompting a user for a selection of one of the parts of speech from a set of choices; responsive to the user selecting one of the set of choices, displaying a set of possible modifications for the selected one; prompting the user for a selection of one of the possible modifications; and identifying if the user has made a proper selection.

In a first variant, the displayed set of choices is comprised of associatively related words.

In a second variant, the displayed set of possible modifications is based on a context for use of the first part of speech. For example, in one such variant, the context is based on either singular and plural use and either masculine and feminine use.

In a third variant, the first part of speech comprises a verb, and the set of possible modifications comprises one or more conjugations of the verb.

In a fourth variant, the first part of speech comprises an adjective, and the set of possible modifications comprises one or more masculine and feminine forms of adjectives.

In a fifth variant, the first part of speech comprises an adjective, and the set of possible modifications comprises one or more singular and plural adjectives.

In a fourth aspect, a personal media device configured for foreign language instruction is disclosed. In one embodiment, a touch screen interface, the touch screen interface configured to display images and accept user input; a processor; and a non-transitory computer readable medium, the computer readable medium comprising at least one computer program stored thereon, the at least one computer program configured to, when executed on the processor: display a first part of speech; and prompt a user for a translation of the one of the parts of speech from a set of cascading choices.

In one such variant, the at least one computer program is further configured to: display the first part of speech within the context of a first sentence.

In a second such variant, the at least one computer program is further configured to: segment the first sentence into a plurality of parts of speech; and prompt the user for translation for each of the segmented parts of speech.

In a third such variant, the user interface is limited to the touch screen interface.

### BRIEF DESCRIPTION OF THE DRAWINGS

FIGS. 1A through 1F are graphical illustrations of one exemplary embodiment of a scheme for foreign language instruction, in accordance with various aspects of the present invention.

FIG. 2 is a logical flow diagram of a generalized method for implementing an improved graphical interface for foreign language instruction via personal media devices.

FIG. 3 is a graphical illustration of one exemplary apparatus configured to assist in foreign language instruction in accordance with various aspects of the present invention.

All Figures© Copyright Matthew Fischler 2011 All Rights Reserved

### DETAILED DESCRIPTION OF THE INVENTION

### Overview—

Methods and apparatus for foreign language instruction that are specifically tailored for available personal computing platform features and limitations are described. Specifically, the aforementioned form factor limitations of personal computing platforms have limited screen space, and seldom use physical keyboards (most rely on a virtualized keyboard). Consequently, in one exemplary aspect of the present invention, a simple interface is described based on a “multiple choice” type selection. Each selection is further “modified” in subsequent steps. By cascading multiple steps for each translation step, the device can represent very complex grammatical constructs without cluttering its user interface. This greatly improves the overall user experience by providing sufficient grammatical depth without requiring a cumbersome user interface.

In one specific embodiment, a device segments a first sentence into a series of fragments. For each of the fragments, the device displays the fragment and prompts the user for the proper translation of the displayed fragment; the translation for the fragment is performed as a series of steps. Thus, rather than providing a limited set of choices (which is too restrictive) or providing text entry (which is onerous and prone to error), the device presents a cascading set of choices. This cascading set of choices can represent a significantly larger set than would otherwise be possible, given the limitations of the user interface. Proper (and improper) selection may be indicated e.g., via a chime, animation, etc.

### Example Operation—

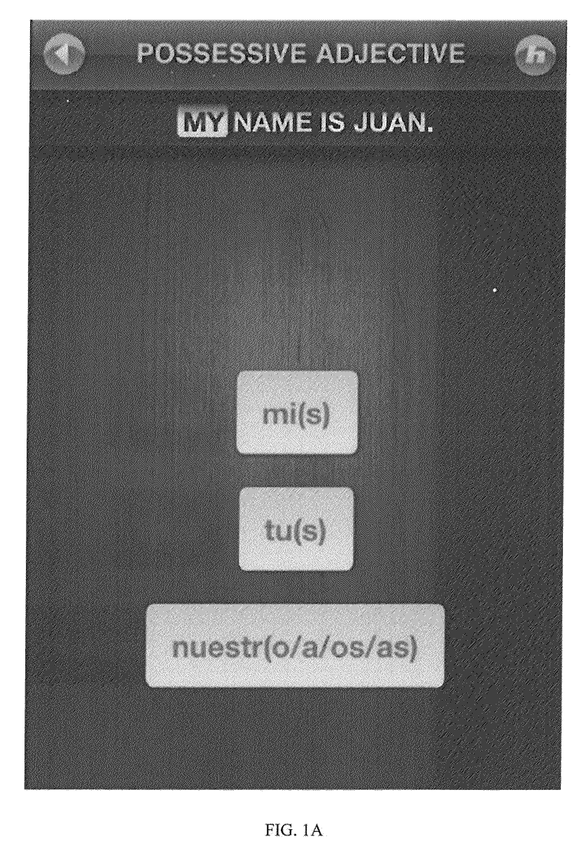

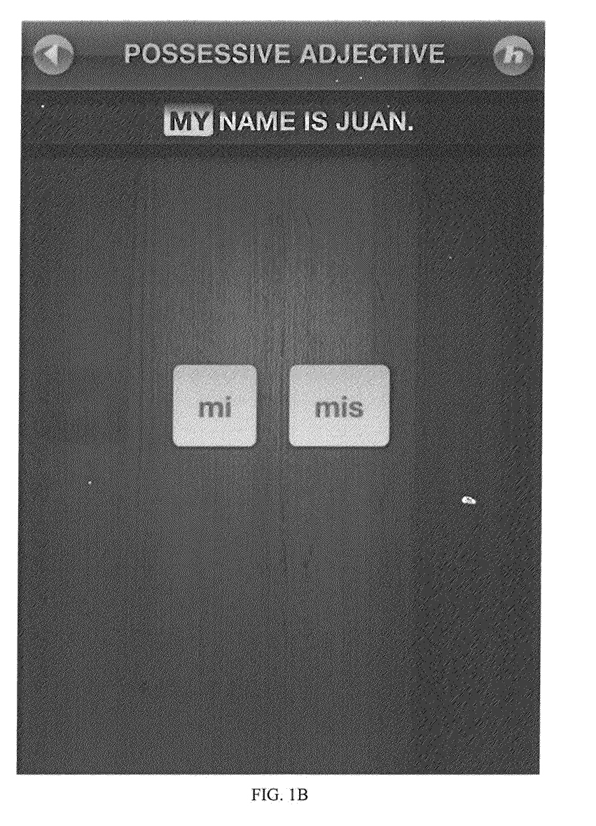

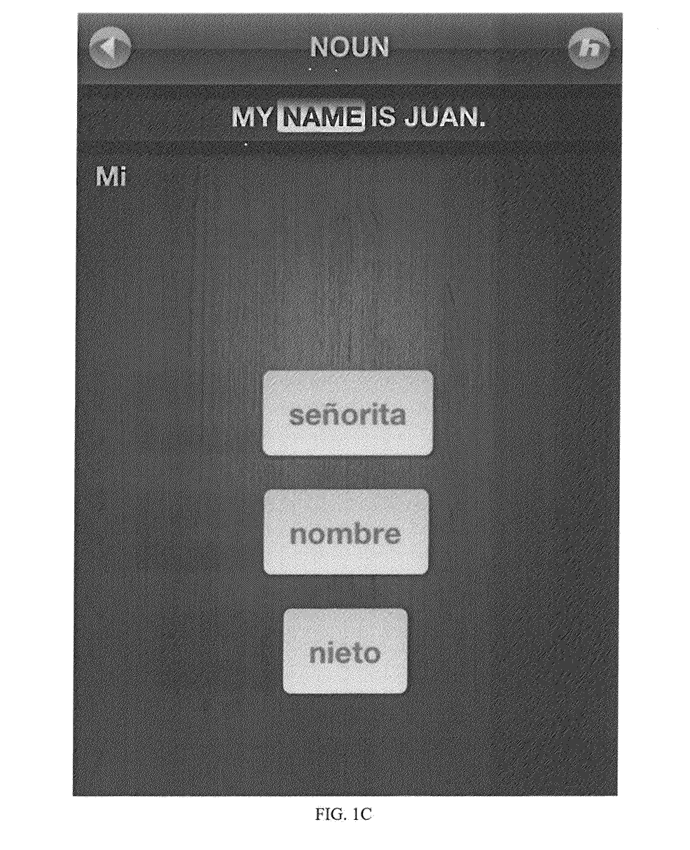

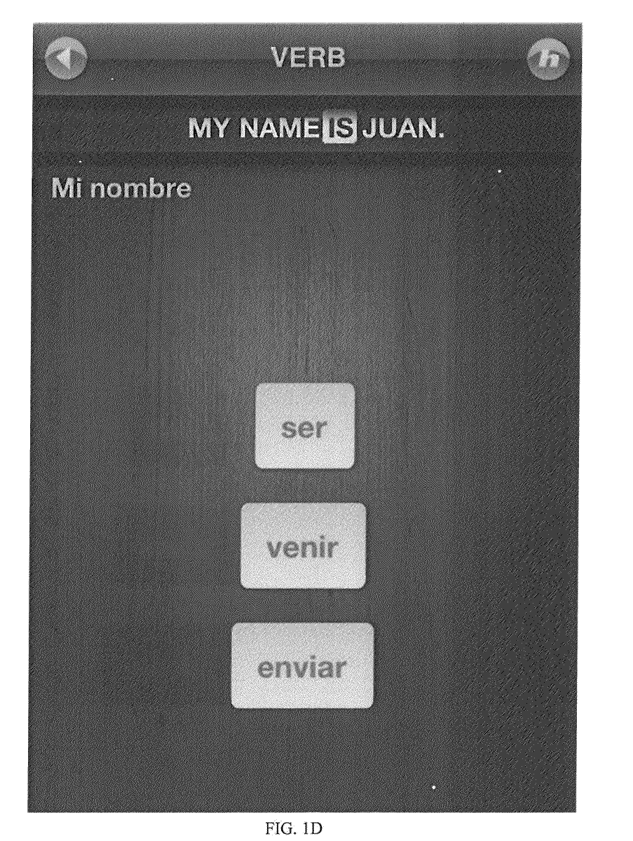

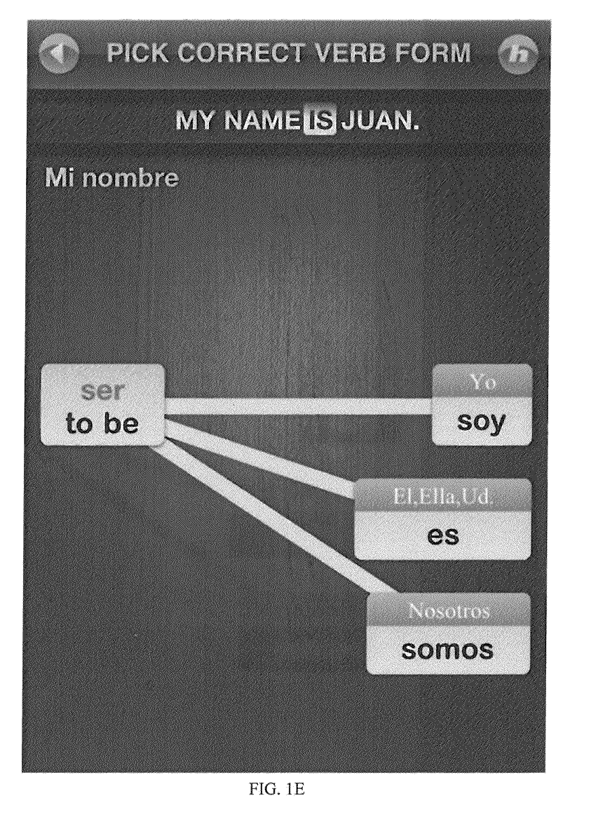

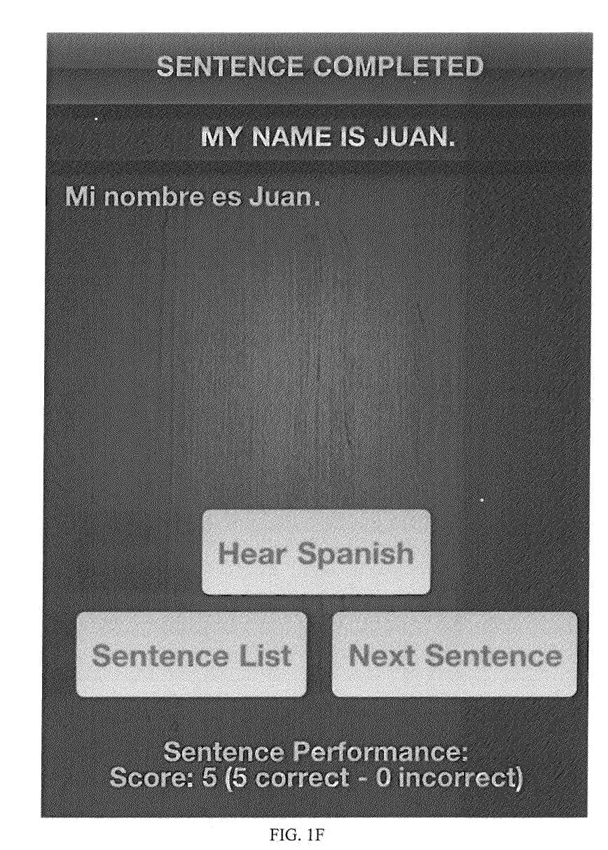

Referring now to FIGS. 1A-1F, one example “lesson” implemented within an exemplary embodiment of the present invention is described. In the exemplary embodiment, a software application is executed on a personal media device having a touch screen interface. During typical operation, the software application displays a first sentence that the user attempts to translate. The first sentence is broken into fragments, and for certain fragments, the user translates the fragment both literally, and then modifies the literal translation in the context of the first sentence.

The user interface comprises several elements: (i) a first sentence, (ii) a fragment of interest (e.g., any part of speech including for example, nouns, pronouns, objects, verbs, adverbs, adjectives, etc.), (iii) a brief description of the fragment of interest, and (iv) one or more selectable options. In the following example, the first sentence is “my name is Juan”, the first fragment is the adjective “my”, the second fragment is the noun “name”, and the third fragment is the verb “is”. “Juan” is a proper noun and does not require translation.

For example, in FIG. 1A, the user interface displays: the first sentence (“my name is Juan”), the first fragment (“my’), a brief description of the first fragment (“possessive adjective”), and the selectable options (“mi(s)”, “tu(s)”, and “nuestr(o/a/os/as)”). The first sentence is provided in a first language (English), and will be translated to a second language (Spanish) by the user.

For each selectable step option, the user can select any one of the selectable options, however only selection of the correct translation will allow the user to proceed to the next step (in this case “mi(s)” is the proper selection). Moreover, selections may be further accentuated with: audible indication, visual indication and/or a running tally. For example, a proper user selection may be accompanied with a positive visual flash (e.g., “+1”), audible positive chime and an incremented answer count; whereas an improper selection may be result in a negative visual flash (e.g., “−1”), audible negative chime, and a decremented answer count. As a brief aside, the selectable options may be determined ahead of time, determined randomly, determined based on a analysis, etc.

Once the user has made the correct selection for FIG. 1A, the user is prompted to properly modify the selection in view of the entirety of the first sentence. As shown in FIG. 1B, the user is prompted for modification of the translated fragment “mi(s)” (e.g., either “mi” or “mis”). Once the user has properly modified the translated fragment in view of the entirety of the first sentence, the user is allowed to proceed to the next fragment (FIG. 1C). It is noted that during the selection step of FIG. 1A, the user was hinted that the selection of “mi(s)” would require further modification, thus FIG. 1B illustrates an exemplary “fixed” modification scenario.

As shown in FIG. 1C, the user is prompted for the translation of the second fragment (“name”). As shown, the second fragment is highlighted, and the brief description now reflects the second fragment. Additionally, in this example, the selectable options presented to the user are randomly selected. The randomly selected options may be selected from a subset of words or phrases which have a high likelihood of being mistakenly picked. For example, the device may present options which appear to sound similar, which have similar meaning, or which are related in some other manner. One such a scheme may present words that are randomly selected from a collected grouping of synonyms, homonyms, antonyms, etc.

FIG. 1D and FIG. 1E illustrate a verb conjugation (third fragment). As shown in FIG. 1D, the user must select the appropriate verb. Once the proper verb has been selected, FIG. 1E provides several possible verb conjugations.

Once the user has successfully completed translation for the entire sentence, FIG. 1F displays the first sentence, and its proper translation in its entirety, and allows the user to e.g., hear the properly translated sentence, progress to other sentences, etc.

The exemplary embodiment of FIGS. 1A-1F offers multiple advantages over existing solutions. For example, free-form text input (e.g., via a real or virtual keyboard) offers significant flexibility in the type and variety of exercises that can be performed; however, those of ordinary skill in the related arts will recognize that the additional flexibility provides only diminishing returns. Specifically, free-form text input is very unforgiving, a misspelled word is as “wrong” as a completely different word. While multiple choice type user interfaces are much more forgiving, multiple choice type user interfaces cannot handle the many permutations required for proper language instruction. For example, a multiple choice type user interface with all possible verb conjugations for even a simple case would be much larger than a simple mobile device can handle.

The foregoing embodiment provides multiple improvements over prior art solutions. For instance, the user interface of the exemplary embodiment can be implemented with very limited user interface capabilities (e.g., very few selectable elements at any one time), while still offering immense depth for the many permutations required to capture the intricacies of true human languages. Moreover, the exemplary embodiment provides much more granularity into a user's understanding of the mechanics of the language; neither free form text entry, or multiple choice answers provide any further depth than “right” or “wrong”. For example, consider a user that is familiar with a particular verb but does not understand proper conjugation; with free form text entry, the user is unlikely to correctly spell the properly conjugated verb, with multiple choice entry the user can select the correct option merely by process of elimination. However, the same user, when presented with the user interface of the exemplary embodiment, must both (i) identify the proper verb, and (ii) conjugate it correctly. This finer granularity is much more useful, especially when assessing the user's overall competency.

### Methods—

While the foregoing discussion has presented one exemplary embodiment of the present invention for purposes of illustration, the following discussions present a generalized method for implementing an improved graphical interface for foreign language instruction via personal media devices, which broadly encompasses multiple aspects of the present invention.

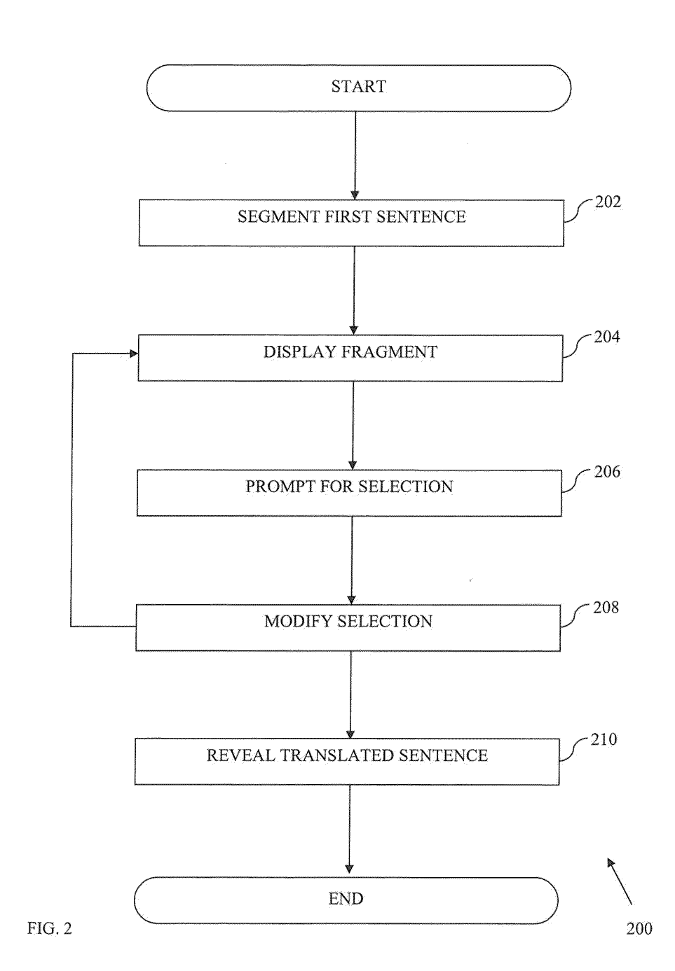

Referring now to FIG. 2, in step 202 of the generalized method 200, a first sentence having a first language is segmented into multiple fragments. In one exemplary embodiment, each fragment comprises a part of speech. In one such variant, the first sentence is fragmented into individual words. In other embodiments, the first sentence may be fragmented into multiple words or phrases (e.g., for example, idioms or other artifacts of speech that cannot be literally translated on a word for word basis may be lumped together). In still other embodiments, grouping several words together may be used to focus more time on subjects of interest. For example, a first sentence may be fragmented such that multiple words that are not of interest are grouped together, whereas the area of interest (e.g., verb conjugation, subject-verb agreement, etc.) is fragmented on a word by word basis.

Furthermore it should be recognized by those of ordinary skill in the related arts, given the disclosure herein, that splitting a sentence into its constituent words and/or phrases is purely illustrative; fragmentation may be performed on a sentence level, or even a paragraph level. For example, some variants may fragment an entire paragraph into distinct sentences; still other variants may fragment a page into multiple paragraphs.

In one exemplary embodiment, the first sentence is segmented into multiple fragments ahead of time. For example, for a relatively simple foreign language instruction software program configured to be executed on a personal media device, the software program may include a fixed “syllabus” of coursework i.e., a number of fixed sentences that have been previously prepared.

Alternately, step 202 may be executed at the time of operation. For example, a software program may fragment a sentence according to user preferences; in one such variant, the user may have included user preferences which dictate certain areas of speech to focus on e.g., verb conjugation, etc.

Once the first sentence has been fragmented, the user can be prompted to iteratively translate each fragment. For example, in one exemplary scheme, the user is allowed to iteratively focus their attention on each of the fragments in a step by step translation process. Specifically, for each fragment step 204, step 206, and in some cases step 208 are performed. Unlike prior art solutions which do not “walk” the user through modification of each fragment, various embodiments of the present invention greatly improve user experience by requiring the user to properly perform multiple aspects of translation in a step by step manner.

Referring now to step 204, a user device displays a fragment (of the multiple fragments) and one or more selectable translation options (e.g., words or phrases), at least one of which is the correctly translated fragment. The correctly translated fragment may not be the finished translated word or phrase.

As a brief aside, within the context of human linguistics, most languages have multiple layers of rules, modifiers and exceptions. For example, as illustrated within TABLE 1, the verb “love” has multiple forms within the Spanish language.

TABLE 1
Indicativo

| | |
|---|---|
| Presente | Pretérito |
| (yo) amo | (yo) amé |
| (tú) amas | (tú) amaste |
| (él) ama | (él) amó |
| (nosotros) amamos | (nosotros) amamos |
| (vosotros) amáis | (vosotros) amasteis |
| (ellos) aman | (ellos) amaron |
| Imperfecto | Futuro |
| (yo) amaba | (yo) amaré |
| (tú) amabas | (tú) amarás |
| (él) amaba | (él) amará |
| (nosotros) amábamos | (nosotros) amaremos |
| (vosotros) amabais | (vosotros) amaréis |
| (ellos) amaban | (ellos) amarán |
| Condicional | |
| (yo) amaría | |
| (tú) amarías | |
| (él) amaría | |
| (nosotros) amaríamos | |
| (vosotros) amaríais | |
| (ellos) amarían | |

Subjuntivo

| | |
|---|---|
| Subjuntivo Presente | Subjuntivo Pasado |
| (yo) ame | (yo) amara |
| (tú) ames | (tú) amaras |
| (él) ame | (él) amara |
| (nosotros) amemos | (nosotros) amáramos |
| (vosotros) améis | (vosotros) amarais |
| (ellos) amen | (ellos) amaran |

Imperativo

| | |
|---|---|
| Imperativo Afirmativo | Imperativo Negativo |
| (yo) — | (yo) — |
| (tú) ama | (tú) no ames |
| (él) ame | (él) no ame |
| (nosotros) amemos | (nosotros) no amemos |
| (vosotros) amad | (vosotros) no améis |
| (ellos) amen | (ellos) no amen |

Tiempos Compuestos

| | |
|---|---|
| Presente Perfecto | Pasado Perfecto |
| (yo) he amado | (yo) había amado |
| (tú) has amado | (tú) habías amado |
| (él) ha amado | (él) había amado |
| (nosotros) hemos amado | (nosotros) habíamos amado |
| (vosotros) habéis amado | (vosotros) habíais amado |
| (ellos) han amado | (ellos) habían amado |
| Futuro Perfecto | Subjuntivo Presente Perfecto |
| (yo) habré amado | (yo) haya amado |
| (tú) habrás amado | (tú) hayas amado |
| (él) habrá amado | (él) haya amado |
| (nosotros) habremos amado | (nosotros) hayamos amado |
| (vosotros) habéis amado | (vosotros) hayáis amado |
| (ellos) habrán amado | (ellos) hayan amado |

Those of ordinary skill in the related arts will recognize that the myriad of verb forms that are used within the Spanish language present multiple problems for a user interface. Specifically, within the context of prior art multiple choice selection, most user interfaces are limited to a relatively small number of selectable options (e.g., four (4) or five (5)) different choices. the limited capabilities of prior art multiple choice selection can not capture the depth of possible verb forms, and significantly limit testing capabilities. Moreover, while prior art text entry can be used by a user to enter the proper verb form, text entry is both tedious and prone to error (e.g., “fat finger” mis-entry, etc.). In fact, certain special characters will often result in close but wrong answer results (e.g., “ñ”, “é”, etc.). Thus, in one exemplary embodiment of the present invention, the user device can accommodate correctly translated fragments in multiple intermediary steps. Specifically, rather than providing an option for the finished translated word or phrase, the user device requires the user to e.g., select the proper intermediate translated word or phrase, and properly modify the intermediate word or phrase within the context of the first sentence. For example, the user may be prompted to select the proper verb (e.g., the infinitive form), and modify the verb according to its proper grammatical “person” (e.g., 1st person singular, 3rd person plural, etc.), and then select the proper verb tense (e.g., indicative, subjunctive, imperative, etc.). By allowing the user to step through multiple steps of translation, the full depth (or a significant portion) of possible modifications can be explored. Moreover, the overall experience is also improved for the user; the user can quickly test grammatically difficult concepts without using a cumbersome user interface.

In one exemplary embodiment, the one or more selectable translation options are randomly selected from a pool of options. Random selection can be used to increase vocabulary, and prevent rote memorization. For example, if the fragment is a verb, the other selectable translation options may be randomly selected verbs; similarly, where the fragment is a noun, adjective, adverb, etc. the other selectable options may be other nouns, adjectives, adverbs, etc.

In one variant of random selection, the randomness may be further narrowed so as to prepare “trickier” translation options. For example, the translation options may appear to sound similar, may have similar meaning, or may be related in some other manner (e.g., commonly mistaken, etc.), even past history (e.g., based on historical data). Common examples include: synonyms, homonyms, antonyms, etc. In one exemplary embodiment, the fragments/words are associatively related in everyday use, so for example, if the proper word is bed, selectable options may include related everyday items, such as: mattress, nightstand, closet, dresser, etc.

In still other embodiments, the one or more selectable translation options are at least partly predetermined. In some variants all the options may be fixed ahead of time. Forcing specific options may help for particularly difficult grammatical rules which would otherwise not be fully tested with a random selection. For example, certain conflict words are difficult for non-native speakers to differentiate; the Spanish words ser and estar are both translated as “to be”, however, their use greatly differs (ser is used to describe essential qualities of an object that do not change, estar is used to describe conditional qualities of an object). Other common examples include: forcing a specific gender test (nouns), a plural test (for example, within the Spanish language, adjectives must agree with the nouns they modify in both gender and plurality), etc. Each language has its own set of peculiarities and rules, it is not uncommon for modifications to be based on: time, mood, context, plurality, gender, formal/informal, etc.

Fixed selections may be desirable for other reasons as well. For example, foreign language instructors may require the ability to configure the device as a software testing platform according to a lesson plan (e.g., to test certain conflict words, etc.). Similarly, a student may configure the device as a learning aid, etc.

Referring back to step 204, it is further appreciated that grammatical rules differ between languages. For example, in English, sentences are typically constructed as a subject verb and object pattern. In other languages, sentences may be constructed differently e.g., as subject object verb, etc. Similarly, certain words have no direct translation and must be translated into multiple words, or conversely, sometimes multiple words are better translated as a single word. Thus, the fragment to be displayed and translated need not be either sequential or a directly map one to one with the one or more selectable translation options.

Still other variations for displaying a fragment and one or more selectable translation options (e.g., words or phrases) will be readily recognized by those of ordinary skill in the related arts, given the present disclosure, the foregoing being merely illustrative.

At step 206, once the device has displayed the fragment and the one or more selectable translation options, the device prompts the user for a selection.

Responsive to the user selection of the corresponding correctly translated fragment, the device presents a positive indication to the user, and for selections that require further modification, the user is allowed to progress to step 208. Common examples of positive indications include for example: positive audio chimes, positive visual cues, vibration, and/or positive scoring. In one such variant, the translation of the correct selection is provided. Similarly, if the user selects an incorrect translation option, then the device presents a negative indication to the user. In some variants, even where the user has made an incorrect selection, the translation of the incorrect selection is also provided. The incorrect translation may further assist in the user's understanding (they can see why their selection was wrong). Common examples of negative indications include for example: negative audio chimes, negative visual cues, vibration, and/or negative scoring.

In one variant, the user is allowed multiple attempts (e.g., repeating step 206). For example, if the user selected the incorrect option, then the device presents the negative indication, but also allows the user to select again. By process of elimination, the user will eventually get the correct selection. In other variants, the user may be limited to a number of attempts. For example, test software may force the user to progress even if the selection is incorrect; the user may be notified of incorrect selection, and force the user to proceed to the next fragment. Similarly, in some cases, a wrong selection may be triggered after a designated time limit. For example, the user may be required to answer within a specified time limit; once the time limit expires, the answer is considered incorrectly answered, and the user is skipped ahead to the next translation step.

In one embodiment, the device further stores metrics for future analysis. Common metrics include for example: correct selections, incorrect selections, type of incorrect selections, untested material, historic performance on a sentence or fragment, etc. In some variants, these metrics may be provided to the user via a summary screen type interface. Other common variants include uploading the metrics to an authorized party such as via an access code.

For translations which do not require further modification, successful selection of the appropriate translated fragment is sufficient to progress to the next fragment. Otherwise, at step 208, the device displays the selected translated fragment and one or more selectable modification options and prompts the user for a selection. These one or more selectable modification options may be determined according to either fixed or random schemes.

Responsive to the user selection of the corresponding correctly modified fragment, the device presents a positive indication to the user; if the user selects an incorrect translation option, then the device presents a negative indication to the user. As with previous step 206, step 208 may allow multiple attempts, limit the number of attempts, enforce designated time limits, track performance metrics, etc.

Furthermore, it will be recognized that multi-tiered hierarchies are possible. For example, where multiple modification steps are necessary, the user may be prompted through each step of the modification process. In this manner, even very complex grammatical rules can be reduced to a series of logically “cascaded” selection steps. For example, within the Spanish language, adjectives are permuted according to singular or plural and feminine or masculine (in some variants, the four options are presented in a single step; alternately, the selection of singular or plural can be performed separately from the steps of selecting masculine or feminine). For Spanish verbs, the verb must be modified according to its proper grammatical “person” (e.g., 1st person singular, 3rd person plural, etc.), and then placed into the proper verb tense (e.g., indicative, subjunctive, imperative, etc.). Similarly, Spanish nouns have singular and plural forms. Moreover, those of ordinary skill in the related arts, given the contents of this disclosure, will recognize that various languages obey different grammatical rules, have different idioms and/or types of word usage, etc. It is further appreciated that the “cascaded” approach detailed herein enables a simple, intuitive, and powerful scheme to assist in foreign language instruction.

Finally, once all fragments have been translated, the entire translated sentence can be revealed at step 210. In one exemplary embodiment, the translated sentence is additionally played back as an audio file.

It will be recognized that while the foregoing scheme has been described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

### Apparatus—

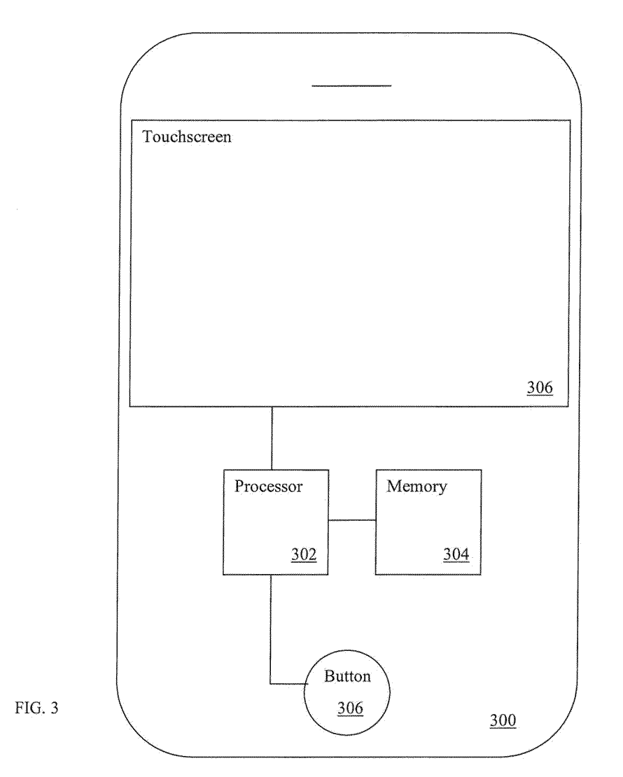

Referring now to FIG. 3, one exemplary apparatus 300 configured to assist in foreign language instruction is shown and described in detail. The exemplary apparatus of FIG. 3 is a personal media device with a processor subsystem 302 such as a digital signal processor, microprocessor, field-programmable gate array (FPGA), or plurality of processing components mounted on one or more substrates. In some embodiments, certain specialized processing elements may be incorporated to further improve overall device performance. In certain designs, one or more multimedia codecs (i.e., encoder, decoder) augment or offload processing from the general purpose processor. For example, an audio codec may offload audio processing from the main processor, e.g., to generate voice playback.

The processing subsystem 302 is connected to a computer-readable media subsystem 304 comprising memory which may for example, include RAM, SRAM, flash, SDRAM, etc. components. The memory subsystem contains computer-executable instructions which are configured for execution by the processor subsystem. In one exemplary embodiment, the memory subsystem may further comprise long term memory storage (e.g., non-volatile memory). Long term memory storage may be useful to e.g., store computer-executable instructions, store user progress, user history and preferences, multimedia files, etc. Examples of long term memory storage include for example flash, and hard disk drives, etc.

The user interface subsystem 306 includes any number of well-known I/O including, without limitation: keypads, mice, button interfaces, touch screens (e.g., multi-touch interface), liquid crystal displays (LCD), backlights, speakers, microphones, vibrators, etc. However, it is recognized that in certain applications, one or more of these components may be obviated. In one embodiment, the display is configured to display one or more elements which are selectable via a user input. In one such embodiment, the user input is received via a multi-touch capable touch screen. The touch screen is configured to register a user's touch based on e.g., capacitive or resistive sensing. In alternate embodiments, the user input is received via a mouse or keyboard input. Still other more exotic interfaces may include, for example voice input, etc.

In one exemplary embodiment, the exemplary apparatus further comprises a network interface. In one embodiment, the network interface comprises a wireless interface. Wireless interfaces typically include at least one or more antennas and a modem. Common examples of wireless interfaces include for example, cellular network interfaces, wireless local area network (WLAN) interfaces, personal area network (PAN) interfaces, etc. Some personal media devices may include multiple wireless interfaces; such as for example, a GSM (or CDMA, LTE, etc.) cellular network interface, a Wi-Fi interface, and a Bluetooth interface. In alternate embodiments, the apparatus may include wire line interfaces. Common examples of wire line interfaces include for example: Ethernet, USB, Firewire, etc.

Referring back to processor 302 and memory subsystems 304, in one exemplary embodiment, the memory comprises non-transitory computer-readable medium that contains instructions which when executed by the processor produce a user interface for language instruction. Generally, the processor is configured to segment a first sentence of a first language into multiple fragments. Subsequently thereafter, the processor is configured to present a user interface (e.g., via a capacitive touch screen). The user interface displays a fragment (of the multiple fragments) and one or more selectable translation options (e.g., words or phrases), at least one of which is the correctly translated fragment.

In various embodiments of the present invention, the apparatus is further configured to based on user selection, indicate positive or negative selection via e.g., audible indication, visual indication and/or a running tally. For example, a proper user selection may be accompanied with a positive visual flash (e.g., “+1”), audible positive chime and an incremented answer count; whereas an improper selection may be result in a negative visual flash (e.g., “−1”), audible negative chime, and a decremented answer count.

Once the device has displayed the fragment and the one or more selectable translation options, the device prompts the user for a selection. For translations which do not require further modification, successful selection of the appropriate translated fragment is sufficient to progress to the next fragment. Otherwise, the device displays (in a step by step manner) a selected translated fragment and one or more selectable modification options and prompts the user for a selection. In this manner, the present invention provides a “cascading” interface. As previously described, those of ordinary skill in the related arts will recognize that the cascading interface provides a more interactive and deeper learning experience for the user.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A method for foreign language instruction via a limited user interface, comprising:
segmenting a first sentence in a first language into a plurality of first parts of speech; and
for one or more of the first parts of speech:
displaying the one or more first part of speech;
displaying a plurality of translated parts of speech in a second language;
wherein each one of the plurality of translated parts has a corresponding selectable element, and one of the translated parts corresponds to the displayed one or more first part of speech;
responsive to a user selection of the corresponding one translated part, indicating a successful selection; and
otherwise indicating an unsuccessful selection.

2. The method of claim 1, further comprising:
responsive to the successful selection, displaying a plurality of modified parts of speech in a second language, wherein each one of the plurality of modified parts has a second corresponding selectable element, and one of the modified parts corresponds to the corresponding one translated part;
responsive to a user selection of the corresponding one modified part, indicating a successful selection; and
otherwise indicating an unsuccessful selection.

3. The method of claim 1, wherein the corresponding one translated part has not been modified with respect to the translated part use in the first sentence.

4. The method of claim 1, where at least a subset of the first parts of speech comprises one or more verbs.

5. The method of claim 1, where the plurality of translated parts are selected randomly.

6. The method of claim 1, where the plurality of translated parts are selected based at least in part on the corresponding one translated part.

7. A method for foreign language instruction via a limited user interface, comprising:
displaying an English verb, the verb having a context within a first sentence;
displaying a plurality of Spanish verbs, wherein each one of the Spanish verbs has a corresponding selectable element, and one of the Spanish verbs corresponds to the English verb;
responsive to a user selection of the Spanish verb that corresponds to the English verb, displaying a plurality of modified versions of the Spanish verb, where one of the modified Spanish verbs corresponds to the context within the first sentence; and
responsive to a user selection of the modifies Spanish verb corresponding to the context within the first sentence, indicating a successful selection.

8. The method of claim 7, wherein the indicating comprises at least one of: an audible indication, a visual indication, and a vibration.

9. The method of claim 7, wherein the plurality of Spanish verbs are displayed in their infinitive form.

10. The method of claim 7, additionally comprising storing a user progress.

11. A method for foreign language instruction via a limited user interface, comprising:
displaying a first part of speech;
prompting a user for a selection of one of the parts of speech from a set of choices;
responsive to the user selecting one of the set of choices, displaying a set of possible modifications for the selected one;
prompting the user for a selection of one of the possible modifications; and
identifying if the user has made a proper selection.

12. The method of claim 11, wherein the displayed set of choices is comprised of associatively related words.

13. The method of claim 11, wherein the displayed set of possible modifications is based on a context for use of the first part of speech.

14. The method of claim 13, wherein the context is based on either singular and plural use and either masculine and feminine use.

15. The method of claim 13, wherein the first part of speech comprises a verb, and the set of possible modifications comprises one or more conjugations of the verb.

16. The method of claim 13, wherein the first part of speech comprises an adjective, and the set of possible modifications comprises one or more masculine and feminine adjectives.

17. The method of claim 13, wherein the first part of speech comprises an adjective, and the set of possible modifications comprises one or more singular and plural adjectives.

18. A personal media device configured for foreign language instruction, the personal media device comprising:
a touch screen interface, the touch screen interface configured to display images and accept user input;
a processor; and
a non-transitory computer readable medium, the computer readable medium comprising at least one computer program stored thereon, the at least one computer program configured to, when executed on the processor:
display a first part of speech; and
prompt a user for a translation of the one of the parts of speech from a set of cascading choices.

19. The personal media device of claim 18, where the at least one computer program is further configured to: display the first part of speech within the context of a first sentence.

20. The personal media device of claim 19, where the at least one computer program is further configured to:
segment the first sentence into a plurality of parts of speech; and
prompt the user for translation for each of the segmented parts of speech.

21. The personal media device of claim 18, where the user interface is limited to the touch screen interface.
